(19) United States
(12) Patent Application Publication
(10) Pub. No.: US 2026/0170617 A1
(43) Pub. Date: Jun. 18, 2026

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Yasuharu HIRADO, Tokyo (JP)

(21) Appl. No.: 19/414,437

(22) Filed: Dec. 10, 2025

(30) Foreign Application Priority Data
Dec. 17, 2024 (JP) 2024-220998

(51) Int. Cl. G06T 5/70; G06T 3/40; G06T 5/80; G06V 10/28; G06V 10/82

(52) U.S. Cl. CPC G06T 5/70; G06T 3/40; G06T 5/80; G06V 10/28; G06V 10/82; G06T 2207/20182

(57) ABSTRACT

An information processing apparatus comprises an image acquisition unit configured to acquire a first image in a first image format with a first bit depth; an image conversion unit configured to convert the first image into a second image in a second image format with the first bit depth by performing rule-based image processing for the first image; an image quantization unit configured to convert the first image into a third image in the first image format with a second bit depth lower than the first bit depth; a correction map estimation unit configured to estimate, based on the third image and a parameter learned in advance, a correction map with the first bit depth for correcting the second image; and an image correction unit configured to generate a corrected image in the second image format by correcting the second image based on the correction map.

### BACKGROUND

### Field of the Technology

The present disclosure relates to an image processing technique.

### Description of the Related Art

In recent years, in image-quality enhancing processing of improving the quality of an image, various methods using a neural network (NN) have been developed. The image-quality enhancing processing indicates image processing such as noise reduction, aberration correction, demosaicing processing, and super-resolution processing.

A recent NN is not limited to image-quality enhancing processing, and has increased in size, and an NN with higher performance tends to require a larger calculation amount. For the purpose of causing such high-performance NN to operate in an apparatus poor in calculation resources such as an incorporated apparatus and increasing the speed of processing in a general-purpose computer, a weight reduction method of reducing the size of the NN and the calculation amount while maintaining the performance as much as possible has been extensively studied.

As one weight reduction method, there is known a method of quantizing the weight or feature amount of the NN into a low-bit depth. By quantizing the NN, it is possible to reduce the calculation amount and the size while maintaining the structure of the NN, thereby causing the NN to operate in an apparatus poor in calculation resources. In addition, a general-purpose computer may be able to use high-throughput operation instruction by quantization, and it can be expected to increase the speed.

However, in a case where it is desirable to estimate a high-quality image with a light weight by an NN having a bit depth lower than that of an image to be output, an image which has been thinned out to have less tones than the original image is output, and the image-quality enhancing performance lowers, as compared with an NN having a bit depth equal to or higher than the bit depth of the image to be output.

Japanese Patent Laid-Open No. 2024-65787 proposes a method of acquiring, in noise reduction of a 14-bit image, a denoise image by inferring a noise component of the image by an 8-bit NN and subtracting the noise component, which is a difference image between the input image and the denoise image, from the input 14-bit image. Although the image inferred by the NN is an 8-bit image, a final image maintains 14-bit tones by subtracting the noise component from the input 14-bit image. On the other hand, because of the 8-bit NN, it is possible to perform processing at high speed.

In Jacob et al., “Quantization and Training of Neural Networks for Efficient Integer-Arithmetic-Only Inference”, CVPR2018 (hereinafter, “Jacob”), fake quantization learning is disclosed. In Yamamoto et al., “Learnable Companding Quantization for Accurate Low-bit Neural Network”, CVPR2021 (hereinafter, “Yamamoto”), a non-uniform quantization method is disclosed.

However, if the data structures of an input image and an output image are different from each other like in a demosaicing processing of converting a Bayer image (1 channel) into an RGB image (3 channels), it is impossible to estimate an image by generating a correction map using an NN having a low-bit depth.

### SUMMARY

To cope with this, the present disclosure provides a technique capable of estimating an image using a correction map generated by an NN having a low-bit depth even though the data structures of an input image and an output image are different from each other.

The present disclosure in its aspect provides an information processing apparatus comprising: an image acquisition unit configured to acquire a first image in a first image format with a first bit depth; an image conversion unit configured to convert the first image into a second image in a second image format with the first bit depth by performing rule-based image processing for the first image; an image quantization unit configured to convert the first image into a third image in the first image format with a second bit depth lower than the first bit depth; a correction map estimation unit configured to estimate, based on the third image and a parameter learned in advance, a correction map with the first bit depth for correcting the second image; and an image correction unit configured to generate a corrected image in the second image format by correcting the second image based on the correction map.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram showing the hardware arrangement of an information processing apparatus according to the first embodiment;

FIG. 2A is a block diagram showing the functional arrangement of the information processing apparatus at the time of inference according to the first embodiment;

FIG. 2B is a block diagram showing the functional arrangement of the information processing apparatus at the time of learning according to the first embodiment;

FIG. 3A is a view for explaining the structure of an 8-bit difference estimation NN of a correction map estimation unit 205 according to the first embodiment;

FIG. 3B is a flowchart for explaining processing in a bit depth conversion layer 306 according to the first embodiment;

FIG. 3C is a flowchart for explaining processing in a final bit depth conversion layer 308 according to the first embodiment;

FIG. 4A is a graph for explaining a tone curve representing nonlinear conversion in bit depth conversion processing according to the first embodiment;

FIG. 4B is a table showing a lookup table indicating final bit depth conversion;

FIG. 5 is a flowchart of inference processing according to the first embodiment;

FIG. 6 is a flowchart of learning processing of the NN according to the first embodiment;

FIG. 7 is a graph for explaining a piecewise linear function used in bit depth conversion processing according to Modification 1;

FIG. 8A is a flowchart of image quantization processing according to Modification 3;

FIG. 8B is a graph of nonlinear conversion according to Modification 3;

FIG. 9A is a block diagram showing the functional arrangement of the information processing apparatus at the time of inference according to Modification 4;

FIG. 9B is a block diagram showing the functional arrangement of the information processing apparatus at the time of learning according to Modification 4;

FIG. 10 is a flowchart of inference processing executed by the information processing apparatus according to Modification 4;

FIG. 11 is a flowchart of inference processing according to Modification 5; and

FIG. 12 is a flowchart of inference processing according to Modification 6.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

As the first embodiment, an information processing apparatus that performs image-quality enhancing processing using a neural network (NN) will be exemplified below.

### <Overview>

This embodiment relates to processing of estimating a quality-enhanced image by machine learning. In the first embodiment, as a practical example, demosaicing processing is targeted.

This embodiment will describe inference processing of an image demosaicing NN and a learning method of the NN. Assume that the bit depth of an image to be processed is 14 bits, and the bit depth (to be referred to as “the bit depth of the NN” hereinafter) of the weight and intermediate feature amount (to be described later) of the NN is 8 bits. However, the bit depth of the image to be processed need only be higher than the bit depth of the NN and the bit depth is not limited to them.

The reason why the effect of this embodiment is obtained will briefly be described by exemplifying demosaicing processing performed in this embodiment. For example, in a case where it is desirable to convert a 14-bit Bayer image (first image format) into an RGB image (second image format), if the RGB image is estimated by an NN in which the bit depth of the weight and intermediate feature amount is 8 bits, an 8-bit RGB image is output from the NN, and thus it is difficult to accurately estimate the RGB image. To cope with this, consider an NN that estimates a correction map for correcting the RGB image having undergone light demosaicing processing. The light demosaicing processing may be rule-based processing or processing by machine learning. The RGB image having undergone the light demosaicing processing will be referred to as a simply processed RGB image hereinafter. The simply processed RGB image is a simple image but is an image of a result close to high-performance demosaicing processing that is preferably implemented by the NN. A map for correcting the simply processed RGB image is inferred by the NN, and it is possible to obtain a sufficiently high-quality image by correcting the simply processed RGB image using 8-bit information. As the ratio of a corresponding pixel value of the correction map to a pixel value of the simply processed RGB image is higher, the image quality is improved more. In addition, since the image quality of the simply processed RGB image is already at a level to some extent, the quality basically does not deviate largely from the simply processed RGB image. Therefore, if conversion into 8 bits is performed to obtain finer tones as a pixel value of the correction map in which the ratio of a corresponding pixel value of the correction map to a pixel value of the simply processed RGB image is necessarily high is lower, a higher-quality RGB image can be obtained.

The hardware arrangement of the information processing apparatus will be described first. After that, the functional arrangements and operations in inference processing and learning processing will be described.

### <Hardware Arrangement>

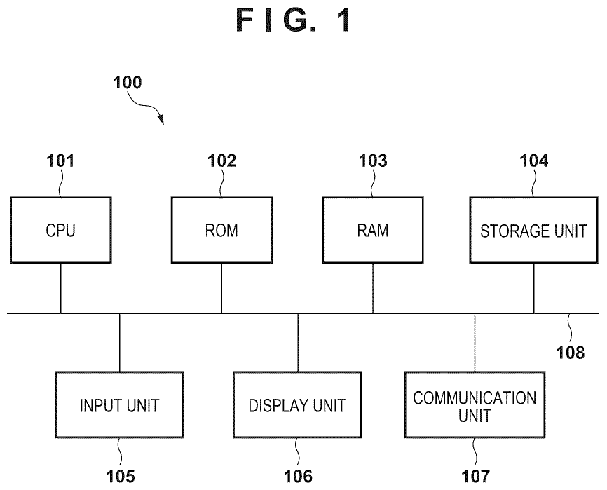

FIG. 1 is a block diagram showing the hardware arrangement of an information processing apparatus 100 according to the first embodiment. Note that inference processing and learning processing may be executed by the same information processing apparatus or different information processing apparatuses. The information processing apparatus 100 includes a CPU 101, a ROM 102, a RAM 103, a storage unit 104, an input unit 105, a display unit 106, a communication unit 107, and a bus 108. The CPU 101, the ROM 102, the RAM 103, the storage unit 104, the input unit 105, the display unit 106, and the communication unit 107 are connected via the bus 108 to be able to transmit/receive data to/from each other.

The CPU 101 is an abbreviation for Central Processing Unit, and is a processor. The CPU 101 controls the overall information processing apparatus 100 by reading out a computer program (to be also referred to as a program hereinafter) such as a control program stored in one of the ROM 102 and the storage unit 104, deploying the program to the RAM 103, and executing the program, thereby implementing all or some of functions to be described later and executing all or some of processes.

Instead of or in addition to the CPU 101, the information processing apparatus 100 may include other processors such as a Micro Processing Unit (MPU), a Graphics Processing Unit (GPU), a Neural Processing Unit (NPU), and a Quantum Processing Unit (QPU). The information processing apparatus 100 may include a plurality of processors of the same type, and the respective processors may implement different functions.

Some or all of the functions of the information processing apparatus 100 may be implemented by one or a plurality of circuits such as an Application Specific Integrated Circuit (ASIC) and a Programmable Logic Device (PLD) including a Field Programmable Gate Array (FPGA).

The ROM 102 is an abbreviation for Read Only Memory, and is a nonvolatile memory. The ROM 102 stores a program such as a Basic Input Output System (BIOS).

The RAM 103 is an abbreviation for Random Access Memory, and is a high-speed read/write memory. The RAM 103 temporarily stores various kinds of data from the respective components. In addition, when the CPU 101 executes a program, the RAM 103 functions as a work area. In this case, the program such as the control program is deployed in the RAM 103 to be executable by the CPU 101.

The storage unit 104 stores a program to be executed by the CPU 101, various kinds of data to be processed by the program in this embodiment, data necessary at the time of executing the program, and the like. For example, the storage unit 104 stores an image to undergo inference processing (demosaicing processing), an image used for learning processing, and various parameters. As a medium of the storage unit 104, a nonvolatile storage device such as a Hard Disk Drive (HDD), a Solid State Drive (SSD), a flash memory, and various kinds of optical media can be used.

The input unit 105 accepts an input of an instruction and information from a user, and outputs them to the CPU 101. The input unit 105 may accept an input from the user via an input device such as a keyboard and a mouse.

The display unit 106 accepts information of a display screen from the CPU 101, and causes a display device to display the display screen. For example, the display unit 106 may cause a display device such as a liquid crystal display or an organic electro luminescence (EL) display to display the display screen.

The communication unit 107 can be an interface for transmitting/receiving data to/from an external apparatus. The communication unit 107 is connected to the external apparatus via a network such as a Local Area Network (LAN) and a Wide Area Network (WAN).

### <Functional Arrangement at Time of Inference Processing>

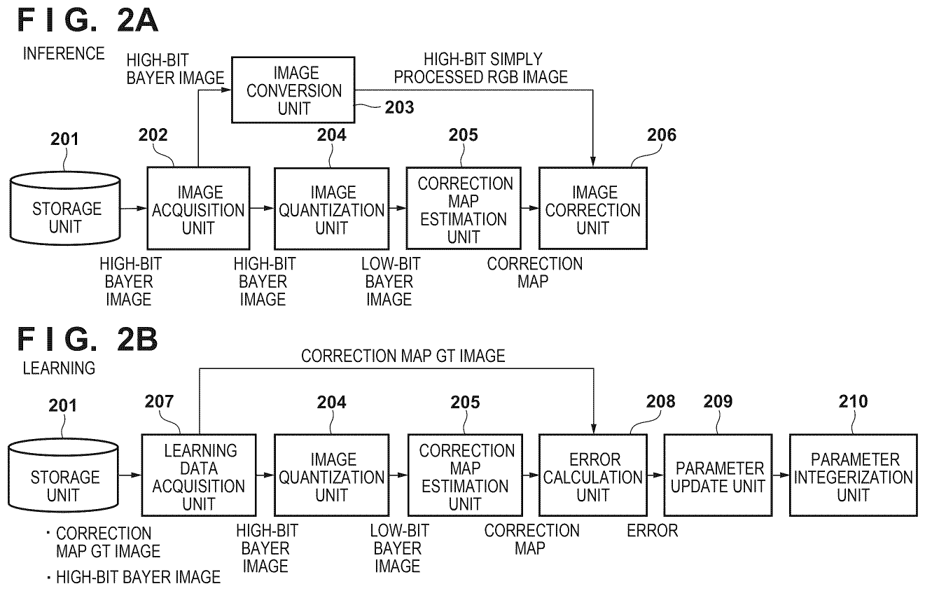

FIGS. 2A and 2B are block diagrams respectively showing the functional arrangements of the information processing apparatus 100 at the time of inference and at the time of learning. FIG. 2A is a block diagram showing the functional arrangement of the information processing apparatus 100 at the time of inference. The information processing apparatus 100 includes a storage unit 201, an image acquisition unit 202, an image conversion unit 203, an image quantization unit 204, a correction map estimation unit 205, and an image correction unit 206. The respective functional components will briefly be described. By reading out an inference program and executing it, the CPU 101 may implement all or some of the image acquisition unit 202, the image conversion unit 203, the image quantization unit 204, the correction map estimation unit 205, and the image correction unit 206.

The image acquisition unit 202 acquires, as an input image, a high-bit (in this example, 14-bit) Bayer image to undergo demosaicing processing from the storage unit 201. In this embodiment, the Bayer image has an RGGB Bayer array, but the array is not limited to this.

The image conversion unit 203 executes demosaicing processing, thereby acquiring, from the high-bit (in this example, 14-bit) Bayer image, a high-bit (in this example, 14-bit) simply processed RGB image having the data structure of an output image. The demosaicing processing executed here may be rule-based light processing. For example, in the demosaicing processing, the image conversion unit 203 may perform linear interpolation processing by R, G, and B pixels. The demosaicing processing need not be rule-based processing as long as it is light processing, and may be processing obtained by learning such as machine learning. The simply processed RGB image has quality lower than that of an image to be originally inferred by the NN, but is close to the image.

The image quantization unit 204 performs quantization processing for the high-bit Bayer image having a bit depth of 14 bits obtained from the image acquisition unit 202 to convert the image into a low-bit Bayer image of an unsigned 8-bit integer. The image quantization unit 204 performs conversion into a low-bit Bayer image using the same uniform quantization method as that in a bit depth conversion layer 306 to be described later. Note that in this example, the bit depth of the NN and the bit depth of the low-bit-depth image are made to match 8 bits but the bit depths may be different from each other. The bit depth of the NN need only be lower than the bit depth of the input image and equal to or higher than the bit depth of the low-bit Bayer image.

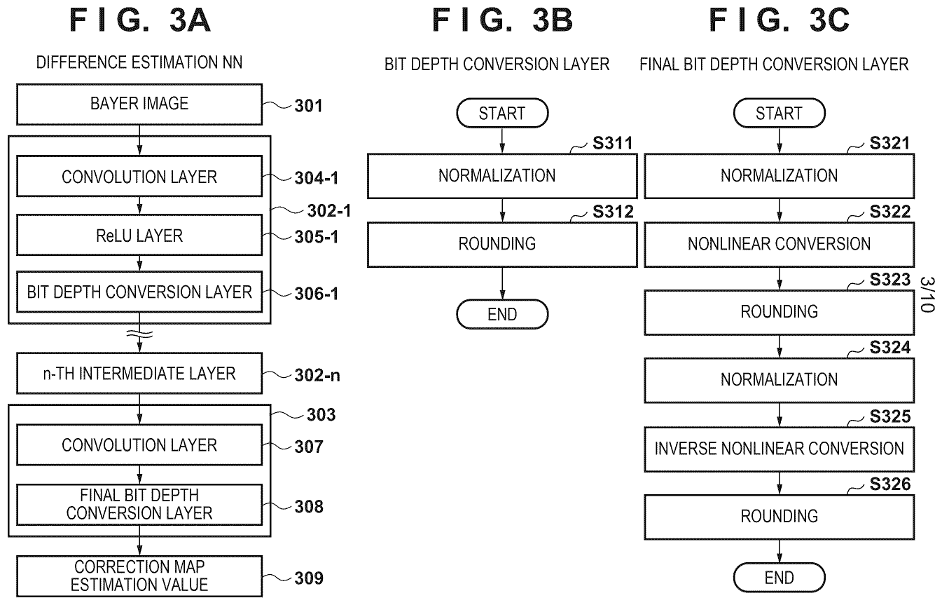

The correction map estimation unit 205 inputs, to the 8-bit difference estimation NN, an 8-bit Bayer image 301 obtained from the image quantization unit 204, and estimates a correction map having 8-bit tones and a range represented by a signed 15-bit integer (correction bit depth). In other words, the correction map has 14 bits which are equal to the bit depth of the input image acquired by the image acquisition unit 202 except for the sign. The correction map according to this embodiment may be a map corresponding to the difference between the simply processed RGB image and the RGB image having quality to be inferred by the difference inference NN. FIGS. 3A to 3C are a view and flowcharts for explaining the difference estimation NN. Details of processing of the difference estimation NN will be described later with reference to FIGS. 3A to 3C.

The image correction unit 206 derives a higher-quality 14-bit RGB image by subtracting, from the simply processed RGB image obtained from the image conversion unit 203, the correction map that has 8-bit tones and a range represented by a signed 15-bit integer and has been estimated by the correction map estimation unit 205. The high-quality 14-bit RGB image is an example of a corrected image. Note that the image correction unit 206 may add the correction map to the simply processed RGB image. In this case, the correction map estimation unit 205 generates a correction map corresponding to addition.

FIG. 3A is a view for explaining the structure of the 8-bit difference estimation NN of the correction map estimation unit 205. The difference estimation NN is also called a correction map estimation NN. The difference estimation NN will sometimes be referred to as the NN hereinafter. The difference estimation NN includes a plurality of intermediate layers 302 and a final layer 303.

The intermediate layers 302 include, for example, intermediate layers from a first intermediate layer 302-1 to an nth intermediate layer 302-n. These intermediate layers will be referred to as the intermediate layers 302 if it is unnecessary to particularly discriminate them. The intermediate layer is an NN that has a weight of a signed 8-bit integer and outputs an unsigned 8-bit integer.

The final layer 303 is arranged at the succeeding stage of the last nth intermediate layer 302-n. The final layer 303 is an NN that has a weight of a signed 8-bit integer and outputs a value having 8-bit tones and a range represented by a signed 15-bit integer.

In the difference estimation NN including the intermediate layers 302 and the final layer 303, the first intermediate layer 302-1 acquires the unsigned 8-bit Bayer image 301, and the final layer 303 outputs a correction map estimation value 309 having 8-bit tones and a range represented by a signed 15-bit integer. The number of intermediate layers may be arbitrary, and is not particularly limited.

The first intermediate layer 302-1 to the nth intermediate layer 302-n have a common internal arrangement, and the internal arrangement of each intermediate layer will be described by exemplifying the first intermediate layer 302-1 as a representative example.

The intermediate layer 302-1 includes a convolution layer 304-1, an ReLU layer 305-1, and a bit depth conversion layer 306-1.

The convolution layer 304-1 performs convolution processing having a weight of a signed 8-bit integer. In the convolution processing, the convolution layer 304-1 multiplies the Bayer image 301 of the unsigned 8-bit integer by the weight (including a bias) of the signed 8-bit integer, and outputs an operation result of a signed 16-bit integer.

The ReLU layer 305-1 performs Rectified Linear Unit (ReLU) processing as nonlinear conversion. The ReLU is processing of outputting 0 for a value equal to or less than 0. Thus, the ReLU layer 305-1 converts the input intermediate feature of the signed 16-bit integer into an unsigned 15-bit integer.

The bit depth conversion layer 306-1 performs processing of converting data of the unsigned 15-bit integer converted in the ReLU layer 305-1 into an unsigned 8-bit integer. To convert the bit depth, a method of uniformly quantizing 15 bits into 8 bits is used in this embodiment, but a nonuniform quantization method represented by Yamamoto may be used. Details of the processing in the bit depth conversion layer 306-1 will be described later with reference to FIG. 3B.

The arrangement of the final layer 303 will be described next. The final layer 303 includes a convolution layer 307 and a final bit depth conversion layer 308.

The convolution layer 307 performs convolution processing having a weight of a signed 8-bit integer, similar to the convolution layer 304, and outputs a correction map of a signed 16-bit integer.

The final bit depth conversion layer 308 converts the correction map of the signed 16-bit integer into a correction map having 8-bit tones and a range represented by a signed 15-bit integer. The final bit depth conversion layer 308 may convert 16-bit tones into 8-bit tones using the nonuniform quantization method represented by Yamamoto. The nonuniform quantization method is a method of reducing a quantization error by devising a tone expression at the time of thinning out and finely representing the effective range of accuracy of the input data, and it can be expected to improve the accuracy of the quantization NN. In the final bit depth conversion layer 308, the nonuniform quantization method is devised to accurately quantize a correction map effective for improvement of image quality. Details of the processing in the final bit depth conversion layer 308 will be described later with reference to FIG. 3C.

Note that the structure of the NN is not limited to that shown in FIG. 3A, and the U-Net structure or the like may be used. The convolution layers 304 and 307 and the ReLU layer 305 are not limited to these, and other linear conversion/nonlinear conversion can be used. The type of each of the intermediate layers 302 and the number of layers are not limited, and need not be the same as the final layer 303. The bit depth of the Bayer image 301 may be higher than 8 bits.

### <Operation at Time of Inference Processing>

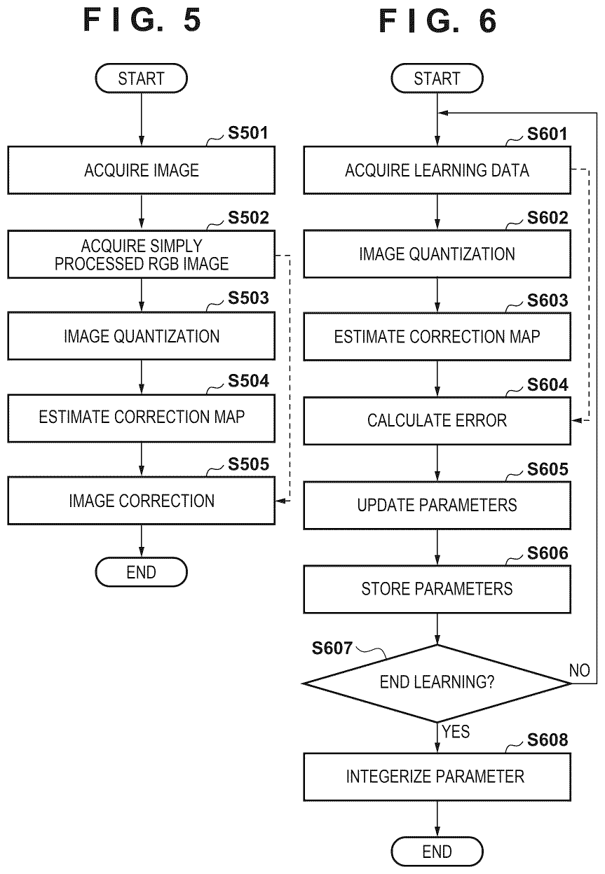

FIG. 5 is a flowchart of inference processing executed by the information processing apparatus 100. However, the information processing apparatus 100 need not always execute all steps described in this flowchart. At the start of the inference processing, the storage unit 201 stores an image to be processed, for example, a high-bit Bayer image.

In step S501, the image acquisition unit 202 acquires a high-bit Bayer image as an input image to undergo demosaicing processing from the storage unit 201. The high-bit Bayer image may be a Bayer image of an unsigned 14-bit integer.

In step S502, the image conversion unit 203 converts the Bayer image of the unsigned 14-bit integer acquired in step S501 by executing demosaicing processing as image processing to acquire a high-bit simply processed RGB image. The high-bit simply processed RGB image may be an image of an unsigned 14-bit integer.

In step S503, the image quantization unit 204 performs quantization processing to convert the Bayer image of the unsigned 14-bit integer acquired in step S501 into the Bayer image 301 of the unsigned 8-bit integer.

In step S504, the correction map estimation unit 205 calculates, from the Bayer image 301 of the unsigned 8-bit integer obtained in step S503, an estimation value having 8-bit tones and a range represented by a signed 15-bit integer, thereby estimating a correction map.

More specifically, the correction map estimation unit 205 inputs the Bayer image 301 of the unsigned 8-bit integer obtained in step S503 to the difference estimation NN shown in FIG. 3A, and subsequently performs the processes in the intermediate layers 302 and the final layer 303. Thus, the correction map estimation unit 205 outputs the correction map estimation value 309 having 8-bit tones and a range represented by a signed 15-bit integer. A case where the bias of the convolution layer 304 and 307 is “0” and the weight is represented by the “signed 8-bit integer” will be described.

First, as a result of a convolution operation of the weight of the signed 8-bit integer and the Bayer image 301 of the unsigned 8-bit integer, the convolution layer 304 obtains an intermediate feature of a signed 16-bit integer as an output. With respect to the output of the convolution layer 304, the ReLU layer 305 converts a negative value into “0” and outputs a positive value intact, thereby obtaining the output represented by an unsigned 15-bit integer. The bit depth conversion layer 306 converts the unsigned 15-bit integer obtained in the ReLU layer 305 into an unsigned 8-bit integer.

As a result of a convolution operation of the weight of the signed 8-bit integer and the intermediate feature of the unsigned 8-bit integer, the convolution layer 307 obtains a correction map of a signed 16-bit integer as an output. The final bit depth conversion layer 308 converts the signed 16-bit integer obtained in the convolution layer 307 into a correction map having 8-bit tones and a range represented by a signed 15-bit integer.

FIG. 3B is a flowchart for explaining the processing in the bit depth conversion layer 306. This processing is processing of converting the input of the unsigned 15-bit integer into an unsigned 8-bit integer.

In step S311, the bit depth conversion layer 306 normalizes the unsigned 15-bit integer output from the ReLU layer 305. More specifically, the bit depth conversion layer 306 performs processing given by equation (1) for an intermediate feature x output from the ReLU layer 305.

$${x}_{inter}^{′} = {x}_{inter} / β \qquad ( 1 )$$

where β is 2¹⁵−1. With this processing, the output is a real number of 15-bit tones having a range of [0, 1]. In this embodiment, normalization is performed by p of 2¹⁵−1. However, xᵢₙₜₑᵣ may be clipped by an arbitrary minimum value and maximum value, and normalized by the difference between the minimum value and the maximum value, thereby acquiring a real number of less than 15-bit tones having a range of [0, 1].

In step S312, the bit depth conversion layer 306 converts the normalized intermediate feature acquired in step S311 into an intermediate feature of an unsigned 8-bit integer by rounding. The map of the intermediate feature of the unsigned 8-bit integer is an example of an intermediate correction map. More specifically, the bit depth conversion layer 306 applies processing given by equation (2) to the output in step S311.

$${x}_{inter}^{″} = ⌈ {s}_{inter} \cdot {x}_{inter}^{′} ⌋ \qquad ( 2 )$$

where sᵢₙₜₑᵣ is 2⁸−1, and the parentheses on the right-hand side represent processing of rounding off a fractional part. The bit depth conversion layer 306 sets the scale of the real number to a range of [0, 2⁸−1], and then rounds off a fractional part, thereby obtaining an unsigned 8-bit integer. With this processing, the bit depth conversion layer 306 converts the unsigned 15-bit integer output from the ReLU layer 305 into an unsigned 8-bit integer. In this embodiment, the bit depth conversion layer 306 performs the processing using the uniform quantization method that does not perform nonlinear processing at the time of quantization, but may perform the processing using the nonuniform quantization method described in Yamamoto.

FIG. 3C is a flowchart for explaining the processing in the final bit depth conversion layer 308. This processing is processing of converting the input represented by a given bit depth into data of a different bit depth. At this time, tone conversion is performed to nonuniformly express tones (finely express tones within a given range and coarsely express tones within another range). This tone conversion corresponds to the nonuniform quantization method described in Yamamoto.

In step S321, the final bit depth conversion layer 308 normalizes the intermediate feature obtained in the convolution layer 307. The intermediate feature is represented by x, and x indicates a map having a width W, a height H, and 3 channels. As illustrated in equation (3), normalization is processing of taking the absolute value of the intermediate feature, clipping the value to a or less, and then normalizing the value to a range of [0, 1], given by:

$${x}^{′} = \{ \begin{matrix}\vert x \vert / α & if \vert x \vert / α \\ 1 & otherwise\end{matrix} \qquad ( 3 )$$

In this example, the parameter α of the clipping range is 2¹⁴−1. The parameter α may be optimized by Bayesian optimization from a plurality of candidates so as to improve the quality of an evaluation image prepared in advance. At this time, a general quantitative indicator such as a Peak Signal-to-Noise Ratio (PSNR) may be used as an image quality index as a target of optimization but the index is not limited to this.

In step S322, as shown in Equation (4) below, the final bit depth conversion layer 308 applies nonlinear conversion fₑ to the normalized intermediate feature obtained in step S321, given by:

$${x}^{″} = {f}_{Θ} ( {x}^{′} ) \qquad ( 4 )$$

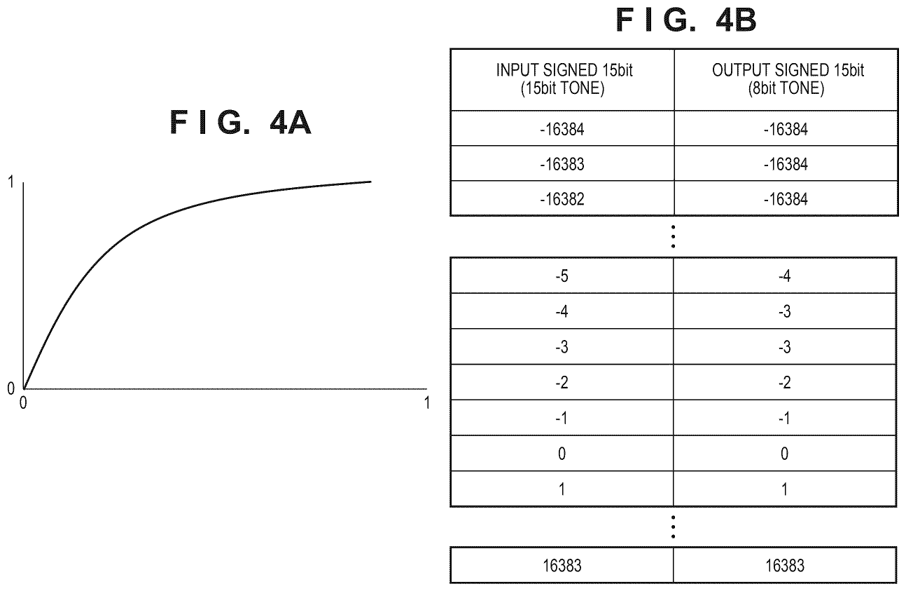

FIGS. 4A and 4B are a graph an a table or explaining the nonlinear conversion processing in the bit depth conversion processing. FIG. 4A is a graph of a tone curve representing the nonlinear conversion f_{θ}. This embodiment will describe a case where the nonlinear conversion can be represented by the tone curve shown in FIG. 4A. First, the normalized map x′ obtained in step S321 is input to the tone curve, thereby obtaining a nonlinearly converted map. With the tone curve, conversion is performed to obtain finer tones as the value is lower and to obtain coarser tones as the value is higher. The nonlinearly converted map has a range of [0, 1], and takes a 14-bit real number.

In step S323, the final bit depth conversion layer 308 converts the output in step S322 into an unsigned 7-bit integer by rounding. More specifically, the final bit depth conversion layer 308 uses equation (5) below.

$${x}^{′′′} = ⌈ {s}_{1} \cdot {x}^{″} ⌋ \qquad ( 5 )$$

where s₁=2⁷−1, and the parentheses on the right-hand side represent processing of rounding off a fractional part. The final bit depth conversion layer 308 sets the scale of the 7-bit real number to a range of [0, 2⁷−1], and then rounds off a fractional part, thereby obtaining an unsigned 7-bit integer. Note that since the final bit depth conversion layer 308 takes the absolute value of x in step S321, it obtains a 7-bit integer instead of an 8-bit integer.

In step S324, the final bit depth conversion layer 308 normalizes again the 7-bit integer obtained in step S323. By using the coefficient of normalization having the same value as that of s₁ in step S323, the final bit depth conversion layer 308 sets the range of the normalized map to [0, 1] to obtain a 7-bit real number. More specifically, the final bit depth conversion layer 308 uses equation (6) below.

$${x}^{′′′′} = {x}^{′′′} / {s}_{1} \qquad ( 6 )$$

In step S325, the final bit depth conversion layer 308 applies inverse nonlinear conversion processing by inverse nonlinear conversion f_{θ}⁻¹ as the inverse function of the nonlinear conversion used in step S322 to the output obtained in step S324. The final bit depth conversion layer 308 returns the value non-linearized in step S322 to be linear by applying the inverse nonlinear conversion f_{θ}⁻¹. The map returned to be linear has a range of [0, 1], and takes a 7-bit real number. More specifically, the final bit depth conversion layer 308 uses equation (7) below.

$${x}^{′′′′′} = {f}_{θ}^{- 1} ( {x}^{′′′′} ) \qquad ( 7 )$$

In step S326, the final bit depth conversion layer 308 converts the 7-bit real number output in step S325 into a signed 15-bit integer of 8-bit tones by rounding. More specifically, the final bit depth conversion layer 308 uses equation (8) below.

$${x}^{′′′′′′} = sign ( x ) \cdot ⌈ {s}_{2} \cdot {x}^{′′′′′} ⌋ \qquad ( 8 )$$

where s₂=2¹⁴−1, and the parentheses on the right-hand side represent processing of rounding off a fractional part. The final bit depth conversion layer 308 sets the scale of the real number to a range of [0, 2¹⁴−1], and then rounds off a fractional part, thereby obtaining an integer of 7-bit tones having the range of [0, 2¹⁴−1]. Since sign(x) is processing of outputting the sign of x, a finally obtained value is an integer of 8-bit tones having a range of [−2¹⁴, 2¹⁴−1].

Since the input Bayer image 301 of the difference estimation NN and the weights and feature amounts in the intermediate layers of the difference estimation NN are represented by 8 bits, it is difficult to accurately infer 9- or more-bit tones as the final output of the difference estimation NN by a high-speed model. To cope with this, the final bit depth conversion layer 308 according to this embodiment applies the nonlinear processing to perform conversion into a low-bit depth, and then applies inverse nonlinear processing to return the range to the original bit depth, as in the processes in steps S321 to S326. With this processing, the final bit depth conversion layer 308 can convert the tones of the correction map into a low-bit depth, and represent, by finer tones, a correction portion having a small absolute value that largely contributes to image quality, thereby suppressing degradation in image quality caused by conversion into low-bit tones. Note that the final bit depth conversion layer 308 converts the tones into 8-bit tones by the processes in steps S321 to S323. However, the present disclosure is not limited to 8 bits, and any bit depth equal to or lower than the parameter α used for clipping in step S321 may be used.

The final bit depth conversion layer 308 may implement processing composed of steps S321 to S326 by performing an arithmetic operation or by using a lookup table (LUT) shown in FIG. 4B. FIG. 4B is a table showing a lookup table indicating final bit depth conversion. The LUT shown in FIG. 4B may correspond to the tone curve shown in FIG. 4A. The final bit depth conversion layer 308 can speed up the nonlinear conversion processing and the inverse nonlinear conversion processing by using the LUT. In this LUT, a region where the absolute value of the correction map is small is converted with fine tones, and conversion is performed with coarser tones as the absolute value of the correction map is larger. If the LUT is used, the final bit depth conversion layer 308 may clip input x by the positive/negative of the parameter α, and convert the input x by the LUT. By using the LUT shown in FIG. 4B, the final bit depth conversion layer 308 can represent, by relatively fine tones, the value range in which the image quality is relatively high.

In step S505, the image correction unit 206 corrects the simply processed RGB image by subtracting, from the simply processed RGB image of the unsigned 14-bit integer obtained in step S502, the estimation value of the correction map that has 8-bit tones and a range represented by the signed 15-bit integer and has been obtained in step S504. This allows the image correction unit 206 to derive the estimation value of a higher-quality 14-bit RGB image as an image obtained by performing demosaicing processing for the Bayer image.

### <Functional Arrangement at Time of Learning Processing>

This embodiment assumes that learning is performed by the framework of pseudo-quantization learning, as in Jacob. In pseudo-quantization learning, the weights and intermediate feature of the model are different from those at the time of inference, and data represented by not an integer but a floating-point number is quantized into 8-bit tones in a pseudo manner and used. A value quantized into 8-bit tones is used when calculating a loss at the time of forward propagation, and a 32-bit value or the like before quantization is used at the time of backpropagation, thereby making it possible to make a small update of the parameters, and reduce an error at the time of inference. A model obtained by performing learning by the framework of pseudo-quantization learning and then performing conversion into an integer using a parameter integerization unit 210 (to be described later) is used at the time of inference.

FIG. 2B is a block diagram showing the functional arrangement of the information processing apparatus at the time of learning. The information processing apparatus 100 includes the storage unit 201, a learning data acquisition unit 207, the image quantization unit 204, the correction map estimation unit 205, an error calculation unit 208, a parameter update unit 209, and the parameter integerization unit 210. The CPU 101 may implement all or some of the learning data acquisition unit 207, the image quantization unit 204, the correction map estimation unit 205, the error calculation unit 208, the parameter update unit 209, and the parameter integerization unit 210 by reading out a learning program and executing it. The storage unit 201 and the image quantization unit 204 are the same as those (FIG. 2A) at the time of inference and a description thereof will be simplified or omitted.

The learning data acquisition unit 207 acquires, from the storage unit 201, the input Bayer image and a Ground Truth (GT) image to be used for learning. The input Bayer image is generated by extracting pixels corresponding to the RGGB array of the Bayer image from the R, G, and B components of the RGB image. The GT image may be the difference between an ideal RGB image and the simply processed RGB image obtained by performing the processing of the image conversion unit 203 for the generated Bayer image. The GT image obtained by this processing is a correct answer map as correct answer data, and can be said as an ideal correction map for correcting the simply processed RGB image into an ideal RGB image. The input image and the GT image are generated in advance and stored in the storage unit 201 in this embodiment, but the RGB image may be stored in the storage unit 201, and then the image conversion unit 203 may generate those images every time using the RGB image. The input image and the GT image have a 14-bit depth.

The correction map estimation unit 205 acquires a model of the difference estimation NN from the storage unit 201. Then, the correction map estimation unit 205 inputs the Bayer image of the 8-bit depth obtained from the image quantization unit 204 to the difference estimation NN of the 8-bit depth, thereby estimating a correction map having 8-bit tones and a range represented by a signed 15-bit integer.

The correction map estimation unit 205 quantizes, as the weights and intermediate feature of the model of the difference estimation NN, data represented by not an integer but a floating-point number into 8-bit tones in a pseudo manner and uses it, unlike data at the time of inference.

The error calculation unit 208 calculates, as an error, a loss with respect to the estimation result of the correction map. More specifically, the error calculation unit 208 calculates an error between the GT image obtained by the learning data acquisition unit 207 and the estimation value of the correction map having 8-bit tones and a range represented by a signed 15-bit integer and estimated by the correction map estimation unit 205. A detailed error calculation method will be described later.

The parameter update unit 209 updates the parameters of the difference estimation NN based on the error obtained by the error calculation unit 208, and stores the updated parameters in the storage unit 201.

The parameter integerization unit 210 quantizes the weights and output of the difference estimation NN that has undergone pseudo-quantization learning, and performs conversion into an integer. As the quantization method of performing conversion into an integer, a known quantization method of the NN is applied and a description thereof will be omitted. Thus, the parameter integerization unit 210 obtains the same output before and after conversion into an integer.

### <Operation at Time of Learning Processing>

FIG. 6 is a flowchart of learning processing of the NN executed by the information processing apparatus 100. However, the information processing apparatus 100 need not always execute all steps described in the flowchart shown in FIG. 6.

In step S601, the learning data acquisition unit 207 acquires, from the storage unit 201, as learning data, the correction map that is a GT image, and the Bayer image to be input. The bit depth of the correction map and the Bayer image is 14 bits.

In step S602, the image quantization unit 204 executes quantization processing to convert the Bayer image of the 14-bit depth acquired in step S601 into a Bayer image of an 8-bit depth, thereby outputting the thus obtained image.

In step S603, by the same procedure as in step S504, the correction map estimation unit 205 estimates a correction map having 8-bit tones and a range represented by a signed 15-bit integer, thereby obtaining an estimation value of a correction map. That is, the correction map estimation unit 205 estimates a correction map having 8-bit tones and a range represented by a signed 15-bit integer from the Bayer image of the 8-bit depth obtained in step S602.

In step S604, the error calculation unit 208 calculates, as an error, a loss Loss₁ with respect to the estimation result of the correction map. The purpose of calculating an error is to advance learning so as to correctly estimate an RGB image as the difference between the simply processed RGB image and the correction map by correctly estimating a correction map from the Bayer image. As given by equation (9) below, the error calculation unit 208 calculates, as the loss Loss₁, the sum (to be also referred to as the L1-distance hereinafter) of the absolute values of the differences between an estimation result C_{inf} of the correction map obtained in step S603 and a correction map C_{gt} as the GT image obtained in step S601. However, the type of the loss is not limited to this.

$${Loss}_{1} = {\sum }_{i} \vert {C}_{inf}^{i} - {C}_{gt}^{i} \vert \qquad ( 9 )$$

In step S605, the parameter update unit 209 updates the parameters of the NN using backpropagation based on the loss Loss₁ calculated in step S604. The updated parameters indicates the weights of the convolution layer 304 and 307 forming the difference estimation NN shown in FIG. 3A.

In step S606, the parameter update unit 209 stores the updated parameters of the difference estimation NN in the storage unit 201. After that, the parameter update unit 209 loads the weights to the difference estimation NN. Steps S601 to S606 are learning of one iteration.

In step S607, the parameter update unit 209 determines whether to end learning. If, in the learning end determination, the value of the loss Loss₁ obtained by equation (9) becomes smaller than a predetermined threshold, the parameter update unit 209 may determine to end learning. Alternatively, if learning is performed a predetermined number of times, the parameter update unit 209 may determine to end learning. The parameter update unit 209 returns to step S601 to repeat the processing until it is determined to end learning. On the other hand, after the parameter update unit 209 determines to end learning, the process advances to step S608.

In step S608, the parameter integerization unit 210 converts the parameters of the difference estimation NN into an integer.

As described above, according to the first embodiment, at the time of inference processing, a correction map is estimated by the NN of a bit depth lower than the bit depth of an image to be processed. Then, in the first embodiment, even if the data structures of an input image and an output image are different from each other, an RGB image corresponding to the data structure of the output image can be estimated and derived by subtracting the estimated correction map from a simply processed RGB image.

Furthermore, in the first embodiment, by applying the nonuniform quantization method (nonlinear conversion processing) in the final layer of the NN having a low-bit depth, the correction map can accurately be represented. Thus, in the first embodiment, it is possible to estimate and output a high-quality image while reducing the processing load.

### Modification 1

Modification 1 will describe a form in which a piecewise linear function is used in the final bit depth conversion layer 308 of the final layer 303. That is, in Modification 1, a piecewise linear function is used as the nonlinear conversion f_{θ}. In Modification 1, by using a piecewise linear function, it is possible to more freely set a range of the input where fine tones are set.

Note that as the piecewise linear function, a function that defines the inclination of each of sections divided at equal intervals may be used, as in non-patent literature 2. In this case, for the piecewise linear function, a section whose inclination is larger is represented by finer tones.

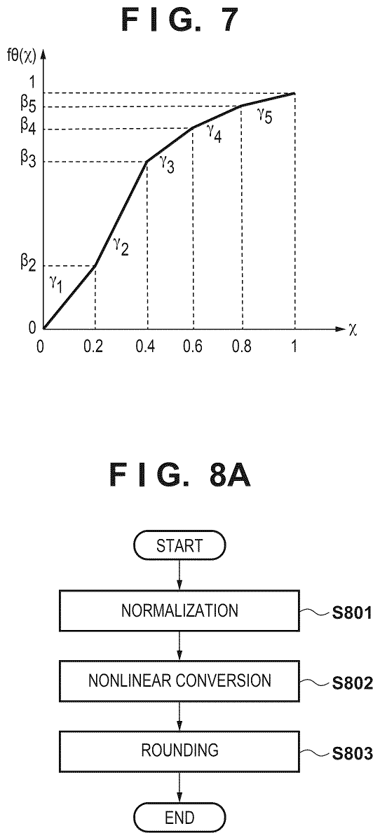

FIG. 7 is a graph for explaining a piecewise linear function used for the bit depth conversion processing in the final bit depth conversion layer 308. This piecewise linear function has five sections obtained by dividing the definition range of [0, 1] of the input at equal intervals, and an inclination γ₂ (=(β₃−β₂)/0.2) of the second section (x=0.2 to 0.4) among inclinations γᵢ (i=1 to 5) of the sections is largest. By using the piecewise linear function, the correction map output from the final bit depth conversion layer 308 is a map in which the tones of the range of the second section are represented most finely.

In a case where a function obtained by performing piecewise linear approximation for the tone curve of the first embodiment is used, the output finally obtained from the final bit depth conversion layer 308 is converted so as to obtain fine tones with respect to the small input and coarse tones with respect to the large input. The final bit depth conversion layer 308 may obtain the inclination of each section of the piecewise linear function by Bayesian optimization or the like, or may perform optimization to improve the quality of an evaluation image prepared in advance by deciding a plurality of candidates. At this time, the final bit depth conversion layer 308 may use a general quantitative indicator such as a PSNR as an image quality index as a target of optimization.

Furthermore, the final bit depth conversion layer 308 or the like may learn the parameter of the piecewise linear function by backpropagation, as in Yamamoto.

As described above, according to Modification 1, by using the piecewise linear function as the nonlinear conversion f_{θ}, the final bit depth conversion layer 308 can increase the degree of freedom of a shape, and increase the degree of freedom of a tone expression, as compared with the first embodiment. In Modification 1, this can effectively suppress degradation in image quality caused by quantization. In Modification 1, by using the method disclosed in Yamamoto, the parameters such as the inclination of the piecewise linear function can be learned by backpropagation together with the weights of the NN, and it is possible to efficiently obtain a tone expression optimum for improving image quality.

### Modification 1-2

In Modification 1 described above, when learning the piecewise linear function and the weights of the NN, the error calculation unit 208 may calculate, in step S604, the loss Loss₁ as an error with respect to the estimation result of the correction map, as follows. More specifically, C_{inf} obtained in step S603, C_{gt} obtained in step S601, and a weighting map wⁱ that has the same width and height as those of the simply processed RGB image used to generate C_{gt} and is the map of weights having different values for respective pixels are prepared in advance. Then, weighting is performed for each pixel with respect to the loss that makes C_{inf} and C_{gt} close to each other. The error calculation unit 208 may calculate the loss Loss₁ based on equation (10) below in a case where the L1-distance is used.

$${Loss}_{1} = {\sum }_{i} {w}^{i} \vert {C}_{inf}^{i} - {C}_{gt}^{i} \vert \qquad ( 10 )$$

The weighting map wⁱ may be decided in accordance with the relationship between the image quality index and a pixel value I. For example, if the image quality index is represented by a function g(I) of the pixel value I, the respective pixel values of the ideal RGB image may be input to the function g(I), thereby obtaining a map having the same width and height. A map obtained by performing normalization by dividing the values of the obtained map by the maximum value of the map may be set as a weighting map.

For example, if a graph in which the abscissa represents the pixel value and the ordinate represents the image quality index g(I) is not a monotonically increasing graph and has a local maximum value, a pixel having a pixel value closer to the local maximum value of the graph has a larger weight wⁱ in the loss calculation of equation (10). Therefore, learning about these pixels preferentially advances. This promotes learning for improving the image quality of a region that influences image quality in learning of the weights of the NN and the parameters of nonlinear conversion.

As described above, according to Modification 1-2, the loss is weighted so that correction map estimation accuracy is higher for a pixel having a pixel value contributing to image quality more largely. This can focus on improving demosaicing processing accuracy of a region with high image quality improving effect.

### Modification 2

In Modification 2, at the time of learning processing, step S322 executed in the final bit depth conversion layer 308 forming the final layer 303 is replaced by identity mapping to implicitly perform nonlinear conversion in the NN. That is, unlike the first embodiment, in Modification 2, nonlinear conversion in step S322 is not explicitly performed. Thus, in Modification 2, at the time of inference processing, it is possible to accurately represent a correction map with less tones while avoiding an increase in processing load caused by nonlinear conversion, and it is possible to improve accuracy of demosaicing processing. Different points from the processing of the first embodiment will mainly be explained in the following description of Modification 2, and a description of the same processing will be simplified or omitted.

### <Operation at Time of Learning Processing>

In step S601, the learning data acquisition unit 207 acquires the input image and the GT image from the storage unit 201. The input image is a Bayer image and the GT image is a correction map. The correction map has undergone nonlinear conversion in advance and has been converted into a signed 8-bit integer. More specifically, nonlinear conversion of the correction map and conversion into a signed 8-bit integer are executed, similar to the processes in steps S321 to S323. The thus obtained correction map is used as the GT image. The type of nonlinear conversion may be the tone curve used in the first embodiment but is not limited to this. Assume that the bit depth of the correction map and the Bayer image is 14 bits.

In step S602, by the same quantization processing as in step S503, the Bayer image of the signed 14-bit integer acquired as the input image in step S601 is converted into a Bayer image of a signed 8-bit integer.

In step S603, by the same procedure as in step S504, the correction map estimation unit 205 obtains the estimation value of the correction map having 8-bit tones and a range represented by a signed 15-bit integer. However, when performing the processing in the final bit depth conversion layer 308 of the difference estimation NN in step S503, the correction map estimation unit 205 according to this embodiment replaces nonlinear conversion applied in the nonlinear conversion processing in step S322 by identity mapping. The processes in steps S324 to S326 are performed only at the time of inference processing and are not performed at the time of learning processing.

In step S604, the error calculation unit 208 calculates the loss Loss₁ with respect to the estimation result of the correction map. The error calculation unit 208 defines the loss Loss₁ to be smaller as the estimation value of the correction map obtained in step S603 is closer to the GT image as the correction map. For example, the error calculation unit 208 may calculate the L1-distance as the sum of the differences between the absolute values of the respective elements, similar to the first embodiment, but the type of the loss is not limited to this.

### <Operation at Time of Inference Processing>

In step S503, the correction map estimation unit 205 changes the processing in the final bit depth conversion layer 308 of the difference estimation NN. More specifically, the final bit depth conversion layer 308 does not execute the processing in step S322 performed in the first embodiment. This is because the NN is learned so as to directly output a result of performing nonlinear conversion at the start of FIG. 3C, by performing the above-described learning processing of this modification.

As described above, the final bit depth conversion layer 308 executes, at the time of inference processing, the processes in steps S324 to S326 that are not performed in the learning processing.

As described above, according to Modification 2, it is configured to implicitly perform nonlinear conversion in the NN in the final bit depth conversion layer 308 at the time of learning processing. Thus, in Modification 2, at the time of inference processing, it is possible to accurately represent a correction map with less tones while avoiding an increase in processing load caused by nonlinear conversion, and it can be expected to improve accuracy of demosaicing processing.

### Modification 3

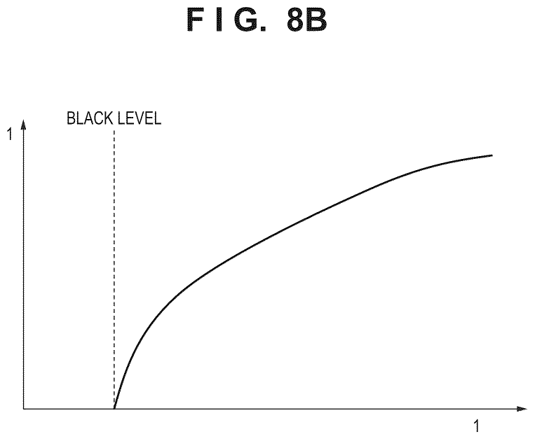

In Modification 3, a method of obtaining a Bayer image of an unsigned 8-bit integer by the nonuniform quantization method by applying nonlinear processing to a Bayer image of an unsigned 14-bit integer in the image quantization unit 204 will be described. FIGS. 8A and 8B are a flowchart and a graph for explaining Modification 3 of the first embodiment.

The correction map estimation unit 205 represents, by finer tones, an image that largely contributes to image quality. To do this, it is desirable to convert input data into 8-bit data in a suitable state. More specifically, it is desirable to represent, by finer tones, a low-luminance region that contributes to image quality more largely.

FIG. 8A is a flowchart of the image quantization processing executed by the image quantization unit 204 according to Modification 3.

In step S801, the image quantization unit 204 normalizes the Bayer image of the 14-bit integer. More specifically, processing given by equation (11) below is performed for the Bayer image of the 14-bit integer.

$${x}_{input}^{′} = {x}_{input} / γ \qquad ( 11 )$$

where γ is 2¹⁴−1. With this processing, the output is converted into a real number of 14-bit tones having a range of [0, 1].

In step S802, the image quantization unit 204 applies nonlinear conversion f_{Φ} to the normalized Bayer image acquired in step S801.

$${x}_{input}^{″} = {f}_{Φ} ( {x}_{input}^{′} ) \qquad ( 12 )$$

FIG. 8B is a graph of the nonlinear conversion f_{Φ} according to this embodiment. Nonlinear conversion performs conversion to obtain finer tones at the black level (OB level) or higher. The black level is the level of a pixel value that is a numerical value within the 14-bit range and serves as a reference of black. A pixel value equal to or lower than the black level is finally determined as black. Since a pixel value equal to or lower than the black level is uniformly determined as black, a value higher than the black level has information as an image. Therefore, it is important to convert the pixel value at the black level or higher into finer tones. In this embodiment, assume that the black level is 2,048.

The nonlinearly converted Bayer image takes a real number having a range of [0, 1].

In step S803, the image quantization unit 204 converts the nonlinearly converted Bayer image acquired in step S802 into an unsigned 8-bit integer. More specifically, the image quantization unit 204 applies processing given by equation (13) below to the output in step S902.

$${x}_{input}^{′′′} = ⌈ {s}_{input} \cdot {x}_{input}^{″} ⌋ \qquad ( 13 )$$

where sᵢₙₚᵤₜ=2⁸−1, and the parentheses on the right-hand side represent processing of rounding off a fractional part. By setting the scale of the 14-bit real number to a range of [0, 2⁸−1], and then rounding off a fractional part, an unsigned 8-bit integer is obtained.

As described above, according to Modification 3, the image quantization unit 204 applies the nonlinear processing to the 14-bit Bayer image, thereby obtaining an unsigned 8-bit image by the nonuniform quantization method. Thus, in Modification 3, it is possible to accurately represent a correction map, and it can be expected to improve accuracy of demosaicing processing.

### Modification 4

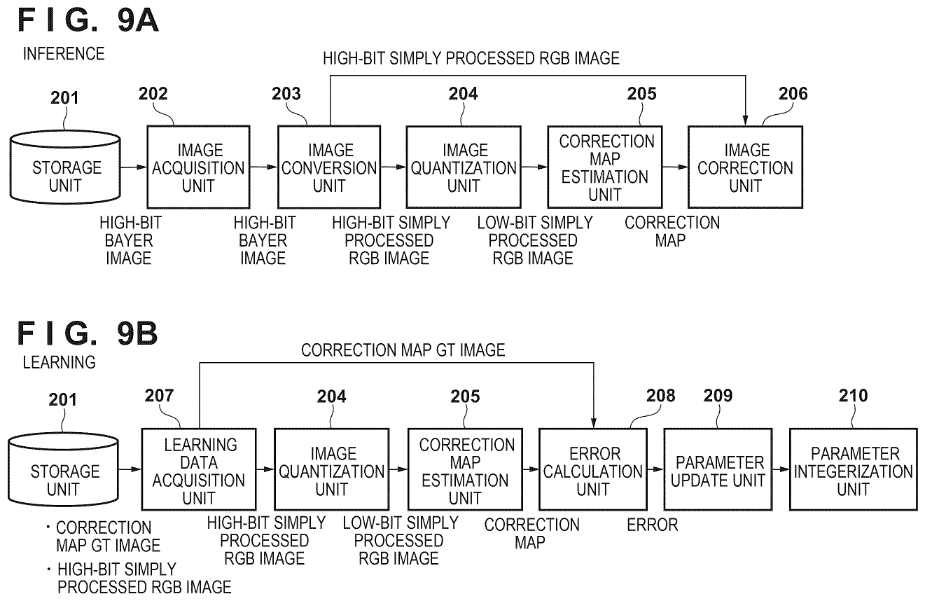

In Modification 4, the correction map estimation unit 205 obtains an RGB image by converting, into a correction map, data obtained by quantizing the simply processed RGB image output from the image conversion unit 203 into 8-bit tones. FIGS. 9A and 9B are block diagrams respectively showing the functional arrangements of the information processing apparatus at the time of inference and at the time of learning according to Modification 4.

FIG. 9A is a block diagram showing the functional arrangement of the information processing apparatus at the time of inference according to this modification. Components modified from the first embodiment will mainly be described and a description of the same components as in the first embodiment will be simplified or omitted.

The image quantization unit 204 performs quantization processing for the simply processed RGB image (high-bit simply processed RGB image) having a 14-bit depth and obtained from the image conversion unit 203, and converts the image into a simply processed RGB image (low-bit simply processed RGB image) of an unsigned 8-bit integer. The image quantization unit 204 according to this modification uses the same uniform quantization method as that of the bit depth conversion layer 306 to be described later but may use the nonuniform quantization method. Note that in this example, the bit depth of the NN and the bit depth of the low-bit-depth image are made to match each other (8 bits) but the bit depths may be different from each other. The bit depth of the NN need only be lower than the bit depth of the input image and equal to or higher than the bit depth of the low-bit Bayer image.

The correction map estimation unit 205 inputs, to the 8-bit NN, the simply processed RGB image of the unsigned 8-bit integer obtained from the image quantization unit 204, and estimates a correction map having 8-bit tones and a range represented by a signed 15-bit integer. The correction map in this modification is a difference map between the simply processed RGB image and the RGB image having quality to be originally inferred by the NN.

The image correction unit 206 derives a higher-quality 14-bit RGB image by subtracting, from the simply processed RGB image obtained from the image conversion unit 203, the correction map that has 8-bit tones and a range represented by a signed 15-bit integer and has been estimated by the correction map estimation unit 205.

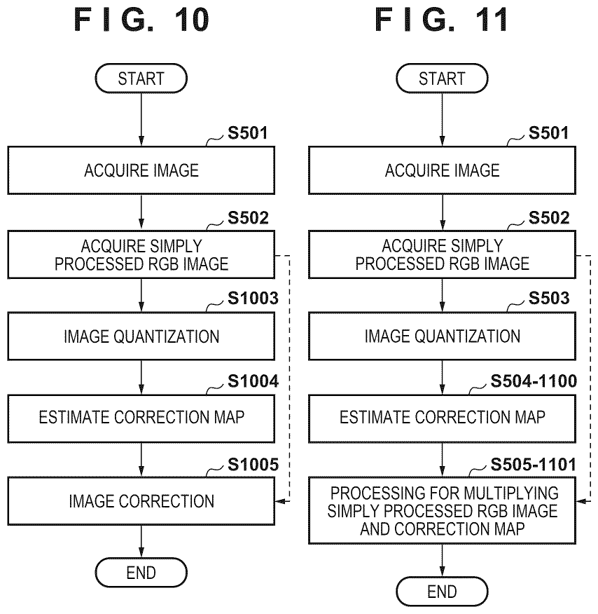

FIG. 10 is a flowchart of inference processing executed by the information processing apparatus according to Modification 4. Steps S501 and S502 are the same as in the processing shown in FIG. 5 and a description thereof will be omitted.

In step S1003, the image quantization unit 204 executes quantization processing to convert the simply processed RGB image of the unsigned 14-bit integer acquired in step S502 into a simply processed RGB image of an unsigned 8-bit integer.

In step S1004, the correction map estimation unit 205 obtains, from the simply processed RGB image of the unsigned 8-bit integer obtained in step S1003, an estimation value of a correction map having 8-bit tones and a range represented by a signed 15-bit integer.

In step S1005, the correction map estimation unit 205 subtracts the estimation value of the correction map obtained in step S1004 from the simply processed RGB image of the unsigned 14-bit integer obtained in step S502. Thus, the correction map estimation unit 205 derives an estimation value of an RGB image as an image obtained by performing demosaicing processing for the Bayer image.

FIG. 9B is a block diagram showing the functional arrangement of the information processing apparatus at the time of learning according to Modification 4. Similar to the description of FIG. 9A, components modified from the first embodiment will mainly be described and a description of the same components as in the first embodiment will be simplified or omitted. The image quantization unit 204 and the correction map estimation unit 205 are the same as in the functional arrangement at the time of inference and a description thereof will be simplified or omitted.

The learning data acquisition unit 207 acquires, from the storage unit 201, the input image and a Ground Truth (GT) image to be used for learning. A high-bit simply processed RGB image as the input image may be generated by the image conversion unit 203 converting a Bayer image generated by extracting pixels corresponding to the RGGB array of the Bayer image from the R, G, and B components of the RGB image. The GT image is the difference between an ideal RGB image and the high-bit simply processed RGB image obtained by performing, for the generated Bayer image, the processing by the image conversion unit 203. The input image and the GT image are generated in advance and stored in the storage unit 201 in this modification, but the RGB image may be stored in the storage unit 201, and then the learning data acquisition unit 207 may generate those images every time using the RGB image and the image conversion unit 203. Assume that the input image and the GT image have a 14-bit depth.

As described above, according to Modification 4, the correction map estimation unit 205 can obtain an RGB image by converting, into a correction map, data obtained by quantizing the high-bit simply processed RGB image output from the image conversion unit 203 into 8-bit tones.

Furthermore, the correction map estimation unit 205 may input a Bayer image generated by extracting pixels corresponding to the RGGB array of the Bayer image from the R, G, and B components of the simply processed RGB image without inputting the simply processed RGB image to the NN.

### Modification 5

Modification 5 will describe a method in which the image correction unit 206 obtains an RGB image by multiplying the simply processed RGB image by the correction map output from the correction map estimation unit 205.

Although the functional arrangement of the information processing apparatus remains unchanged, the processing of the correction map estimation unit 205 and the image correction unit 206 for estimating a correction map is different from the above examples, and different points will mainly be described.

Instead of the correction map corresponding to the difference between the simply processed RGB image and the higher-quality RGB image, the correction map estimation unit 205 outputs, as a correction map, a map corresponding to the ratio between the simply processed RGB image and a higher-quality RGB image corresponding to a corrected image by an NN (to be also referred to as a ratio estimation NN). The correction map estimation unit 205 may output a correction map having 8-bit tones and a range represented by a signed 15-bit integer.

The image correction unit 206 derives a higher-quality 14-bit RGB image by multiplying the 14-bit simply processed RGB image obtained from the image conversion unit 203 by the correction map that has 8-bit tones and a range represented by a signed 15-bit integer and has been estimated by the correction map estimation unit 205. Instead of multiplication, the image correction unit 206 may divide the simply processed RGB image by the correction map. In this case, the correction map estimation unit 205 generates a correction map corresponding to division.

FIG. 11 is a flowchart of inference processing according to Modification 5. Steps S501 to S503 are the same as in the processing of the flowchart shown in FIG. 5 and a description thereof will be omitted.

In step S504-1100, the correction map estimation unit 205 generates, as a correction map, a map of the ratio between the simply processed RGB image and the higher-quality RGB image and outputs the map.

In step S505-1101, the image correction unit 206 multiplies the 14-bit Bayer image obtained in step S501 by the estimation value of the correction map obtained in step S504. Thus, the image correction unit 206 derives an estimation value of an RGB image as an image obtained by performing demosaicing processing for the Bayer image.

As described above, according to Modification 5, the correction map estimation unit 205 generates a correction map by the ratio between the simply processed RGB image and the higher-quality RGB image. Thus, the image correction unit 206 can obtain an RGB image by multiplying the simply processed RGB image by the correction map output from the correction map estimation unit 205.

### Modification 6

Modification 6 will describe a method in which the image correction unit 206 obtains an RGB image by calculating the difference between the simply processed RGB image and a map obtained by multiplying the simply processed RGB image by the correction map output from the correction map estimation unit 205.

Although the functional arrangement of the information processing apparatus remains unchanged, the processing of the correction map estimation unit 205 and the image correction unit 206 for estimating a correction map is different from Modification 5. Therefore, in a description of Modification 6, different points will mainly be explained.

The correction map estimation unit 205 generates, by an NN (to be also referred to as a difference ratio estimation NN hereinafter), as a correction map, a map corresponding to the ratio between a simply processed RGB image and a difference map between the simply processed RGB image and a higher-quality RGB image corresponding to a corrected image. The correction map estimation unit 205 generates a correction map having 8-bit tones and a range represented by a signed 15-bit integer.

The image correction unit 206 generates, as a difference map, a map obtained by multiplying the simply processed RGB image obtained from the image conversion unit 203 by the estimated correction map. Instead of multiplication, the image correction unit 206 may divide the simply processed RGB image by the correction map. In this case, the correction map estimation unit 205 generates a correction map corresponding to division.

The image correction unit 206 derives a higher-quality 14-bit RGB image by subtracting the difference map from the simply processed RGB image obtained from the image conversion unit 203. Instead of subtraction, the image correction unit 206 may add the correction map to the simply processed RGB image. In this case, the correction map estimation unit 205 generates a correction map corresponding to addition.

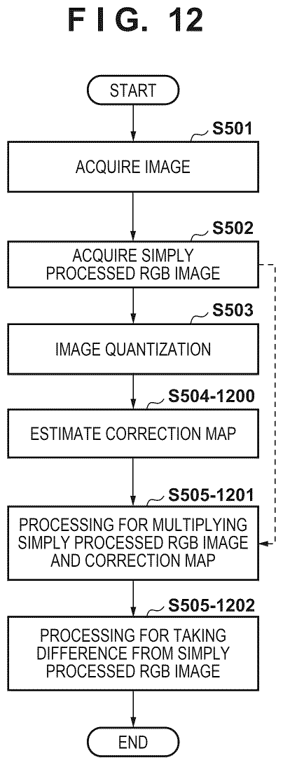

FIG. 12 is a flowchart of inference processing according to Modification 6. Steps S501 to S504-1200 are the same as in the processing up to step S504 in the flowchart shown in FIG. 5 or 11 and a description thereof will be omitted.

In step S505-1201, the image correction unit 206 multiplies the simply processed RGB image obtained in step S502 by the estimation value of the correction map obtained in step S504. Thus, the image correction unit 206 derives a difference map between the simply processed RGB image and the higher-quality RGB image.

In step S505-1202, the image correction unit 206 subtracts the difference map obtained in step S505-1201 from the simply processed RGB image obtained in step S502. Thus, the image correction unit 206 derives an estimation value of an RGB image as an image obtained by performing demosaicing processing for a Bayer image.

As described above, according to Modification 6, the image correction unit 206 can obtain an RGB image by calculating the difference between the simply processed RGB image and a difference map obtained by multiplying the simply processed RGB image by the correction map output from the correction map estimation unit 205.

Note that the processes of the embodiments including the modifications are not limited to the demosaicing processing, and with the same arrangement, the present disclosure can be applied to other image processes, for example, noise reduction, aberration correction, and high-resolution processing for a super resolution (or high resolution), as a matter of course. Note that the information processing apparatus can execute image processing such as demosaicing processing, noise reduction, aberration correction, and high-resolution processing, and may execute image processing in accordance with user selection. The nonlinear processing executed by the image quantization unit 204 or the correction map estimation unit 205 may be improved in performance by an ensemble of a plurality of nonlinear processes.

According to the present disclosure, it is possible to provide a technique of estimating a high-quality image using an NN having a low-bit depth.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220998, filed Dec. 17, 2024 which is hereby incorporated by reference herein in its entirety.

What is claimed is:

1. An information processing apparatus comprising:
an image acquisition unit configured to acquire a first image in a first image format with a first bit depth;
an image conversion unit configured to convert the first image into a second image in a second image format with the first bit depth by performing rule-based image processing for the first image;
an image quantization unit configured to convert the first image into a third image in the first image format with a second bit depth lower than the first bit depth;
a correction map estimation unit configured to estimate, based on the third image and a parameter learned in advance, a correction map with the first bit depth for correcting the second image; and
an image correction unit configured to generate a corrected image in the second image format by correcting the second image based on the correction map.

2. The apparatus according to claim 1, wherein
the correction map estimation unit estimates, based on the third image, a correction map corresponding to a difference between the second image and the corrected image, and
the image correction unit corrects the second image by adding or subtracting the correction map to or from the second image.

3. The apparatus according to claim 1, wherein
the correction map estimation unit estimates, based on the third image, a correction map corresponding to a ratio between the second image and the corrected image, and
the image correction unit corrects the second image by multiplying or dividing the second image by the correction map.

4. The apparatus according to claim 1, wherein
the correction map estimation unit estimates the correction map corresponding to a ratio between the second image and a difference map corresponding to a difference between the second image and the corrected image, and
the image correction unit corrects the second image by adding or subtracting, to or from the second image, a difference map obtained by multiplying the second image by the correction map.

5. The apparatus according to claim 1, wherein
the correction map estimation unit includes a neural network having a third bit depth lower than the first bit depth and not lower than the second bit depth, and
the neural network estimates the correction map by estimating an intermediate correction map with the third bit depth from the third image and converting the bit depth of the intermediate correction map with the third bit depth into the first bit depth.

6. The apparatus according to claim 5, wherein
the neural network includes a bit depth conversion layer which generates the correction map, and
the bit depth conversion layer
generates the intermediate correction map with the third bit depth by converting the bit depth after performing nonlinear conversion processing for the intermediate correction map, and
generates the correction map having tones of the third bit depth by converting the bit depth into the first bit depth after performing, for the intermediate correction map with the third bit depth, inverse nonlinear conversion processing by an inverse function of the nonlinear conversion processing.

7. The apparatus according to claim 6, wherein
the bit depth conversion layer converts the bit depth by one of a lookup table and an arithmetic operation including an operation by a piecewise linear function.

8. The apparatus according to claim 5, wherein
the third bit depth is equal to the second bit depth.

9. The apparatus according to claim 1, wherein
the image quantization unit generates the third image from the first image by processing including nonlinear conversion processing.

10. The apparatus according to claim 9, wherein
the image quantization unit generates the third image by the nonlinear conversion processing of converting a pixel value larger than a pixel value of a black level into finer tones than a pixel value of the black level.

11. The apparatus according to claim 1, wherein
the image acquisition unit acquires, as the first image, an image having a Bayer array including the first bit depth, and
the image correction unit outputs, as the corrected image, a 3-channel RGB image with the first bit depth.

12. The apparatus according to claim 1, wherein
the image correction unit outputs, as the corrected image, an image obtained by removing noise of the first image.

13. The apparatus according to claim 1, wherein
the image correction unit outputs, as the corrected image, an image obtained by correcting an aberration of the first image.

14. The apparatus according to claim 1, wherein
the image correction unit outputs, as the corrected image, a high-resolution image obtained by increasing a resolution of the first image.

15. The apparatus according to claim 1, wherein
the image conversion unit converts the first image into the second image with the first bit depth, and
the image quantization unit converts the second image into the third image.

16. The apparatus according to claim 1, wherein
the image quantization unit converts the first image into the third image.

17. An information processing apparatus for learning a neural network, comprising:
a learning data acquisition unit configured to acquire one of a first image with a first bit depth and a second image obtained by performing image processing for the first image, and a correct answer map with the first bit depth as correct answer data of a correction map;
an image quantization unit configured to convert the acquired first image or second image into a third image with a second bit depth lower than the first bit depth;
a correction map estimation unit configured to estimate, by the neural network, based on the third image, the correction map with the first bit depth for correcting the second image; and
an update unit configured to update a parameter of the neural network based on an error between the correct answer map and the correction map.

18. The apparatus according to claim 17, wherein
the neural network
generates an intermediate correction map with a third bit depth lower than the first bit depth and not lower than the second bit depth by converting the bit depth after performing nonlinear conversion processing for the third image, and
generates the correction map having tones of the third bit depth by converting the bit depth into the first bit depth after performing, for the intermediate correction map with the third bit depth, inverse nonlinear conversion processing by an inverse function of the nonlinear conversion processing.

19. An information processing method comprising:
acquiring a first image in a first image format with a first bit depth;
converting the first image into a second image in a second image format with the first bit depth by performing rule-based image processing for the first image;
converting the first image into a third image in the first image format with a second bit depth lower than the first bit depth;
estimating, based on the third image and a parameter learned in advance, a correction map with the first bit depth for correcting the second image; and
generating a corrected image in the second image format by correcting the second image based on the correction map.

20. A non-transitory computer-readable storage medium storing a computer program that, when read and executed by a computer, causes the computer to:
acquire a first image in a first image format with a first bit depth;
convert the first image into a second image in a second image format with the first bit depth by performing rule-based image processing for the first image;
convert the first image into a third image in the first image format with a second bit depth lower than the first bit depth;
estimate, based on the third image and a parameter learned in advance, a correction map with the first bit depth for correcting the second image; and
generate a corrected image in the second image format by correcting the second image based on the correction map.
